(19) United States
(12) Patent Application Publication
(10) Pub. No.: US 2026/0312881 A1
(43) Pub. Date: Oct. 8, 2026

(54) SPLIT LEARNING FOR SENSING-AIDED BEAM SELECTION

(71) Applicant: Telefonaktiebolaget LM Ericsson (publ), Stockholm (SE)

(72) Inventors: Ycaro DANTAS, Gatineau (CA); Pedro Enrique ITURRIA RIVERA, Ottawa (CA); Hao ZHOU, Ottawa (CA); Melike EROL-KANTARCI, Ottawa (CA); Majid BAVAND, Ottawa (CA); Medhat ELSAYED, Nepean (CA); Raimundas GAIGALAS, Hässelby (SE); Yigit OZCAN, Gloucester (CA)

(21) Appl. No.: 19/476,962

(22) PCT Filed: Apr. 29, 2024
(86) PCT No.: PCT/IB2024/054159

§ 371 Date: Oct. 20, 2025

Related U.S. Application Data
(60) Provisional application No. 63/499,225, filed on Apr. 29, 2023.

(51) Int. Cl. H04L 41/16; G01S 19/33; G06N 3/08

(52) U.S. Cl. CPC H04L 41/16; G01S 19/33; G06N 3/08

(57) ABSTRACT

A method performed by a server network node configured to communicate with a plurality of clients is provided. Each of the plurality of clients is configured with a client-side neural network model. The method includes receiving a first plurality of client-side neural network model outputs from the plurality of clients, each of the first plurality of client-side neural network model outputs being computed based on at least one of a plurality of input datasets associated with the plurality of clients. The method includes at least one of determining at least a portion of a label dataset; and receiving at least a portion of the label dataset from at least one other network node. The method includes performing split learning using the first plurality of client-side neural network model outputs and a server-side neural network model with the label dataset.

### FIELD

The present disclosure relates to wireless communications, and in particular, to configurations for supporting split learning for sensing-aided beam selection.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

Fifth generation (5G) radio networks are typically more disaggregated than fourth generation (4G) radio networks, meaning that the radio-network may be subdivided into a multitude of components that interwork across standardized interfaces and well-defined application programming interfaces (APIs). This is partly specified in Third Generation Partnership Project (3GPP) specifications that define the radio access network (RAN) components such as distributed unit (DU), central unit control plane (CU-CP) and central unit user plane (CU-UP) interworking over the standardized E1 and F1 interfaces. The Open RAN (O-RAN) industry initiative (www.o-ran.org) takes RAN disaggregation even further by specifying the components O-RAN radio unit (O-RU), O-RAN distributed unit (O-DU), O-RAN central unit control plane (O-CU-CP), near real time RAN intelligent controller (NearRT-RIC) and non-real time RAN intelligent controller (NonRT-RIC) interworking across the E2 and A1 interfaces.

Beam selection, the procedure of selecting an optimal beam from a pre-defined codebook, is usually achieved based on beam sweeping strategies, where the expected performance of each candidate beam may be assessed through reference signals. In some exiting systems, the exhaustive search over the full codebook may diminish a miss detection probability, but may increase delay and overhead. Moreover, beam selection may be subject to optimization in mmWave systems, and machine learning (ML)-based methods have been applied to this end. The use of ML methods aided by multi-modal sensing information may offer promising results. Thus, it may be considered as an alternative to support beam selection in new RAN architectures and next generation networks.

In some existing systems, performing an exhaustive search over the full codebook, i.e., a baseline approach to beam selection, may be a cause of delay and overhead. Sensing-aided solutions, which may leverage ML methods to map contextual information inputs to an optimal beam decision, may be used as an alternative, and multi-modal approaches have been tested with reasonable performance. Considering the motive of using data-driven methods for intelligent optimization within the RAN, internal and external databases may play an important role in supporting different network functions. In an open and multi-vendor disaggregated RAN environment, for example, it is expected that multiple applications (named rApps and xApps in Open RAN) may simultaneously use the same data sources containing contextual information to enable multiple network functions. For beam selection network functionality, other applications that could leverage similar types of contextual data describing the environment (e.g., user location) include, for instance, mobility management and traffic steering. Within the same RAN environment, the developers of such applications may vary (equipment vendor, network operator, third party enterprises, etc.), as do the maintainers of the contextual information databases to support its operations. New challenges may arise in this multi-external data sources and multi-applications RAN environment, such as:
Privacy: Some data sources may carry sensitive information (e.g., user location and camera images), which may be carefully processed.
Data Ownership: Data is treated as an asset. In a multi-vendor RAN, data ownership may impose constraints on the sharing of raw data with third-party applications and platforms.
Performance: The sharing of high-volume data with multiple applications may overload communication and processing within the management and orchestration platform.

Thus, existing systems lack suitable configurations for supporting split learning for sensing-aided beam selection.

### SUMMARY

Some embodiments advantageously provide methods, systems, and apparatuses for supporting split learning for sensing-aided beam selection.

Embodiments of the present disclosure relate to a sensing-aided beam selection solution based on split learning (SL), which may be configured for disaggregated and multi-vendor RAN environments, for example. For example, in some embodiments, contextual information may be collected by multi-modal sensing operations and stored at independent external sources to support beam selection decisions using a distributed machine learning (ML) method that may account for privacy and data ownership issues.

Some embodiments of the present disclosure relate to beam selection assisted by multi-modal sensing operations. Considering that multiple data sources, e.g., for multi-modal sensing information, may be used to support the beam selection decision, and that such data sources may be owned by multiple parties in a disaggregated and multi-vendor RAN environment, embodiments of the present disclosure may enable privacy and data protection using, e.g., Split Learning (SL) on the training and inference phases of applications based on Neural Networks (NN).

Thus, embodiments of the present disclosure may support split learning applied to beam selection supported by multi-modal sensing information stored at independent external data sources in a disaggregated and multi-vendor RAN environment.

Embodiments of the present disclosure may provide a solution to multi-modal sensing-aided beam selection in the case of a multi-external data sources and multi-applications RAN environment.

Embodiments of the present disclosure may provide techniques for optimization of a beam selection task using a data-driven method and accounting for possible implications on its deployment alongside third-party applications and on the use of external data sources maintained by third parties.

Embodiments of the present disclosure may enable improved (i.e., over existing systems) privacy and data protection when using databases from multiple owners to support the training and inference on a machine learning-based RAN application.

Embodiments of the present disclosure may, for example, be suitable for novel RAN architectures that consider intelligent control layers and access to external databases.

According to one aspect of the present disclosure, method performed by a server network node configured to communicate with a plurality of clients, each of the plurality of clients being configured with a client-side neural network model is provided. The method includes receiving a first plurality of client-side neural network model outputs from the plurality of clients, each of the first plurality of client-side neural network model outputs being computed based on at least one of a plurality of input datasets associated with the plurality of clients. The method includes at least one of: determining at least a portion of a label dataset; and receiving at least a portion of the label dataset from at least one other network node. The method includes: performing split learning using the first plurality of client-side neural network model outputs and a server-side neural network model with the label dataset.

According to one or more embodiments of this aspect, performing the split learning includes: determining, using the server-side neural network model and the first plurality of client-side neural network model outputs, a first plurality of server-side neural network parameters; and transmitting the first plurality of server-side neural network parameters to each of the plurality of clients.

According to one or more embodiments of this aspect, method further includes performing a beam selection inference for a first user equipment based on the server-side neural network model.

According to one or more embodiments of this aspect, the label dataset corresponds to at least one of: millimeter wave, mmWave, data associated with at least one of the plurality of clients; radio measurement data associated with at least one of the plurality of clients; and network performance data associated with at least one of the plurality of clients.

According to one or more embodiments of this aspect, the plurality of input datasets correspond to at least one of: camera data associated with at least one of the plurality of clients; light detection and ranging, LiDAR, data associated with at least one of the plurality of clients; and global positioning system, GPS, data associated with at least one of the plurality of clients.

According to one or more embodiments of this aspect, a first input dataset of the plurality of input datasets is one of: accessible by a first client of the plurality of clients and not accessible by at least one other client of the plurality of clients; and only accessible by the first client of the plurality of clients and not accessible by all other clients of the plurality of clients.

According to another aspect of the present disclosure, a server network node configured to communicate with a plurality of clients, each of the plurality of clients being configured with a client-side neural network model is provided. The server network node is configured to receive a first plurality of client-side neural network model outputs from the plurality of clients, each of the first plurality of client-side neural network model outputs being computed based on at least one of a plurality of input datasets associated with the plurality of clients. The server network node is configured to at least one of: determine at least a portion of a label dataset; and receive at least a portion of the label dataset from at least one other network node. The server network node is configured to perform a split learning using the first plurality of client-side neural network model outputs and a server-side neural network model with the label dataset.

According to one or more embodiments of this aspect, performing the split learning includes: determining, using the server-side neural network model and the first plurality of client-side neural network model outputs, a first plurality of server-side neural network parameters; and transmitting the first plurality of server-side neural network parameters to each of the plurality of clients.

According to one or more embodiments of this aspect, server network node is further configured to perform a beam selection inference for a first user equipment based on the server-side neural network model.

According to one or more embodiments of this aspect, the label dataset corresponds to at least one of: millimeter wave, mmWave, data associated with at least one of the plurality of clients; radio measurement data associated with at least one of the plurality of clients; and network performance data associated with at least one of the plurality of clients.

According to one or more embodiments of this aspect, the plurality of input datasets correspond to at least one of: camera data associated with at least one of the plurality of clients; light detection and ranging, LiDAR, data associated with at least one of the plurality of clients; and global positioning system, GPS, data associated with at least one of the plurality of clients.

According to one or more embodiments of this aspect, a first input dataset of the plurality of input datasets is one of: accessible by a first client of the plurality of clients and not accessible by at least one other client of the plurality of clients; and only accessible by the first client of the plurality of clients and not accessible by all other clients of the plurality of clients.

According to another aspect of the present disclosure, a method performed by a first client configured to communicate with a server network node, the server network node being configured to communicate with a plurality of clients, the plurality of clients including the first client, each of the plurality of clients being configured with a client-side neural network model, is provided. The method includes at least one of receiving and determining a first input dataset associated with the first client. The method includes determining, using a first client-side neural network model, a first client-side neural network model output. The method includes communicating the first client-side neural network model output to the server network node for performing split learning using a plurality of client-side neural network model outputs from the plurality of clients and a server-side neural network model with a label dataset.

According to one or more embodiments of this aspect, method further includes: based on the first client being a first user equipment, receiving a beam selection configuration based on a beam selection inference for the first user equipment based on the server-side neural network model.

According to one or more embodiments of this aspect, method further includes: based on the first client being a first network node, determining a beam selection configuration based on a beam selection inference for a first user equipment and the first network node based on the server-side neural network model; and transmitting an indication of the beam selection configuration to the first user equipment.

According to one or more embodiments of this aspect, the label dataset corresponds to at least one of: millimeter wave, mmWave, data associated with at least one of the plurality of clients; radio measurement data associated with at least one of the plurality of clients; and network performance data associated with at least one of the plurality of clients.

According to one or more embodiments of this aspect, the first input dataset corresponds to at least one of: camera data associated with at least one of the plurality of clients; light detection and ranging, LiDAR, data associated with at least one of the plurality of clients; and global positioning system, GPS, data associated with at least one of the plurality of clients.

According to one or more embodiments of this aspect, the first input dataset is one of: accessible by the first client and not accessible by at least one other client of the plurality of clients; only accessible by the first client and not accessible by all other clients of the plurality of clients.

According to another aspect of the present disclosure, a first client configured to communicate with a server network node, the server network node being configured to communicate with a plurality of clients, each of the plurality of clients being configured with a client-side neural network model, is provided. The first client is configured to at least one of receive and determine a first input dataset associated with the first client. The first client is configured to determine, using a first client-side neural network model, a first client-side neural network model output. The first client is configured to communicate the first client-side neural network model output to the server network node for performing split learning using a plurality of client-side neural network model outputs from the plurality of clients and a server-side neural network model with a label dataset.

According to one or more embodiments of this aspect, first client is further configured to: based on the first client being a first user equipment, receive a beam selection configuration based on a beam selection inference for the first user equipment based on the server-side neural network model.

According to one or more embodiments of this aspect, first client of is further configured to: based on the first client being a first network node, determine a beam selection configuration based on a beam selection inference for a first user equipment and the first network node based on the server-side neural network model; and transmit an indication of the beam selection configuration to the first user equipment.

According to one or more embodiments of this aspect, the label dataset corresponds to at least one of: millimeter wave, mmWave, data associated with at least one of the plurality of clients; radio measurement data associated with at least one of the plurality of clients; and network performance data associated with at least one of the plurality of clients.

According to one or more embodiments of this aspect, the first input dataset corresponds to at least one of: camera data associated with at least one of the plurality of clients; LiDAR data associated with at least one of the plurality of clients; and GPS data associated with at least one of the plurality of clients.

According to one or more embodiments of this aspect, the first input dataset is one of: accessible by the first client and not accessible by at least one other client of the plurality of clients; only accessible the first client and not accessible by all other clients of the plurality of clients.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a server network node according to some embodiments of the present disclosure;

FIG. 8 is a flowchart of an example process in a first client according to some embodiments of the present disclosure;

FIG. 9 is a flowchart of another example process in a server network node according to some embodiments of the present disclosure;

FIG. 10 is a flowchart of another example process in a first client according to some embodiments of the present disclosure;

FIG. 11 is a diagram illustrating an example architecture and process flow in a communication system according to some embodiments of the present disclosure;

FIG. 12 is a diagram illustrating an example architecture and process flow in a communication system according to some embodiments of the present disclosure;

FIG. 13 is a diagram illustrating an example architecture and process flow in a communication system according to some embodiments of the present disclosure; and

FIG. 14 is a diagram illustrating an example architecture and process flow in a communication system according to some embodiments of the present disclosure.

### DETAILED DESCRIPTION

Before describing in detail example embodiments, it is noted that the embodiments reside primarily in combinations of apparatus components and processing steps related to split learning for sensing-aided beam selection. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

Further, a network node may be or may include a Central Unit (CU or gNB-CU) and/or one or more Distributed Units (DU or gNB-DU). For example, a gNB may include a gNB-CU and gNB-DUs. CUs may be logical nodes that host higher-layer protocols and perform various gNB functions such controlling the operation of DUs. A DU (e.g., gNB-DU) may be a decentralized logical node that hosts lower layer protocols and can include, depending on the functional split option, various subsets of the gNB functions. As such, each of the CUs and DUs may include various circuitry needed to perform their respective functions, including processing circuitry, transceiver circuitry (e.g., for communication), and power supply circuitry. Moreover, the terms “central unit” and “centralized unit” may be used interchangeably herein, as are the terms “distributed unit” and “decentralized unit.”

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

It is to be understood that the terms “client” and “server” as used herein are not to be construed as limiting, but rather, are intended to encompass a wide range of wired or wireless devices/entities that participate in a network or communication system. For example, a “client” may refer to, but is not limited to, a network node, base station, wireless device, user equipment, or any other electronic device capable of initiating or receiving data transmissions from a “server.” Similarly, a “server” may refer to, but is not limited to, a host computer, network node, cloud node, or any other electronic device capable of responding to requests from a “client” or otherwise providing data or services to a “client.” The scope of the terms “client” and “server” extends to any electronic devices/entities that are connected through wired or wireless means and participate in communication or data exchange processes, without limitation to specific hardware or software configurations.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide configurations and methods for supporting split learning for sensing-aided beam selection.

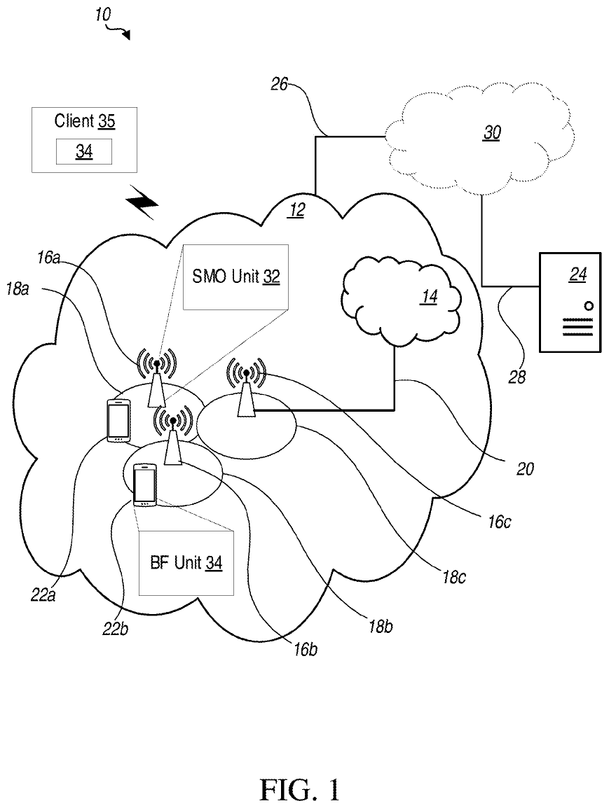

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a SMO unit 32 which is configured for supporting split learning for sensing-aided beam selection. A wireless device 22 is configured to include a Beamforming unit 34 which is configured for supporting split learning for sensing-aided beam selection.

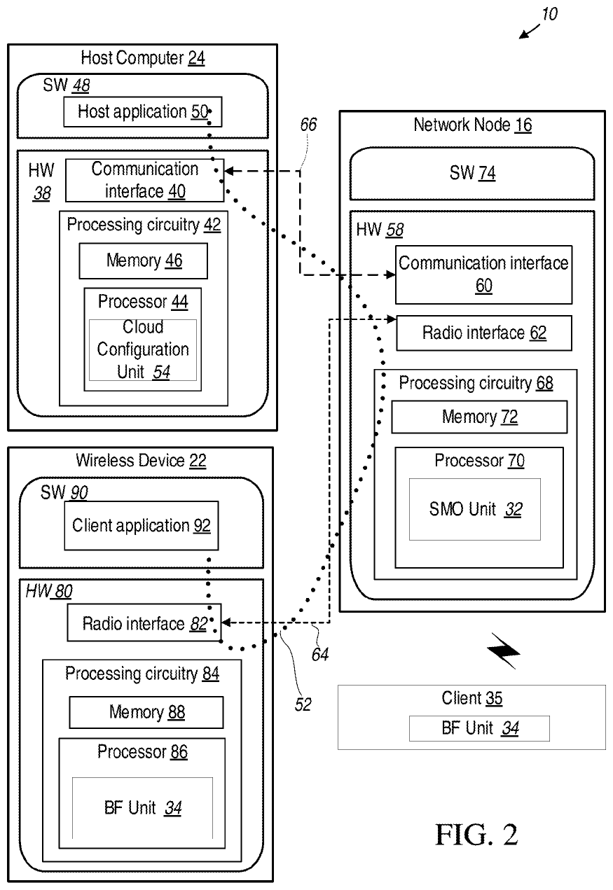

Further, system 10 may further comprise client device and/or system 35 (referred to as “client 35”). In one or more embodiments, client 35 is part of access network 12 or intermediate network(s) 30. Client 35 may comprise similar hardware as WD 22 and/or network node 16 described below with respect to FIG. 2, but may further comprise one or more databases operated by a network operator, equipment vendor or third-party entity. Client 35 may operate a client neural network and perform one or more BW beamforming unit 34 functions, as described herein, thereby allowing network node 16 (i.e., server network node 16) to perform split learning functions and beamforming functions.

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a Cloud Configuration unit 54 configured to enable the service provider to observe/monitor/control/transmit to/receive from/etc. the network node 16 and or the wireless device 22, including with respect to supporting split learning for sensing-aided beam selection.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include SMO unit 32 configured for supporting split learning for sensing-aided beam selection.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a Beamforming unit 34 configured for supporting split learning for sensing-aided beam selection.

Further, client 35 may comprise the same or similar hardware as wireless device 22 and/or network node 16 but with size and performance varying based on implementation of client 35. Further, client 35 may operate a client-side neural network and further comprise one or more databases where client 35 is operated by an entity such as for example, a network operator, equipment vendor, third-party entity, etc. The dataset(s) stored in the one or more databases may be used for split learning as described herein.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as SMO unit 32, and Beamforming unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

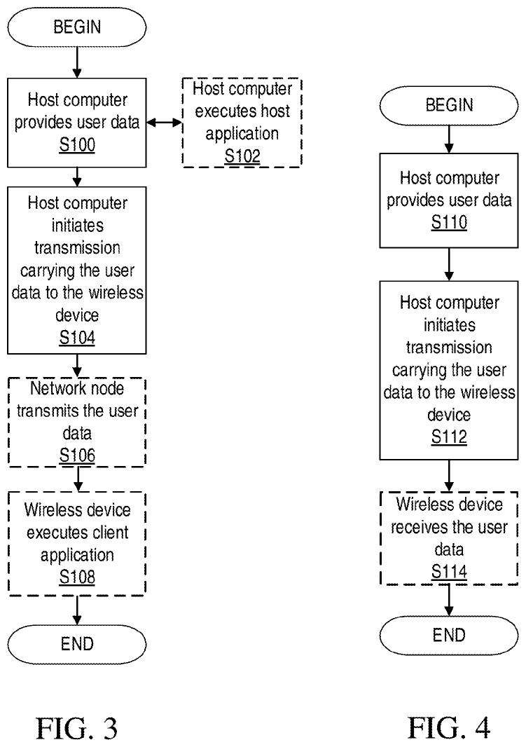

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S110). The transmission may pass via the network node 16, in accordance with the teachings of the embodiments described throughout this disclosure. In an optional third step, the WD 22 receives the user data carried in the transmission (Block S120).

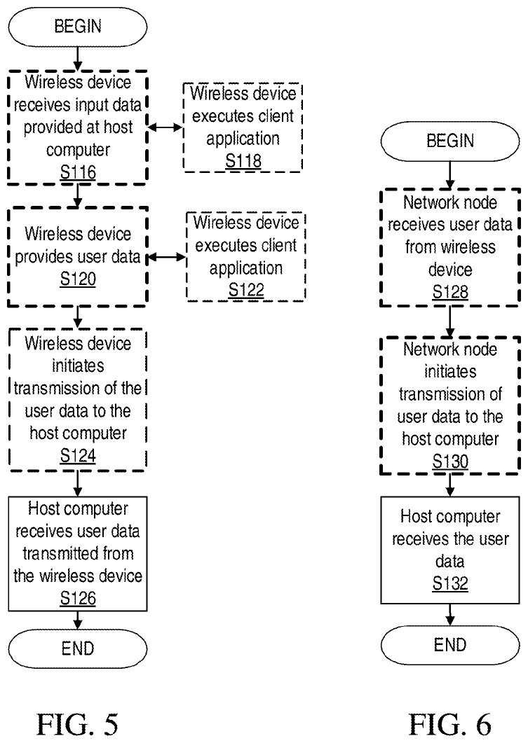

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S122).

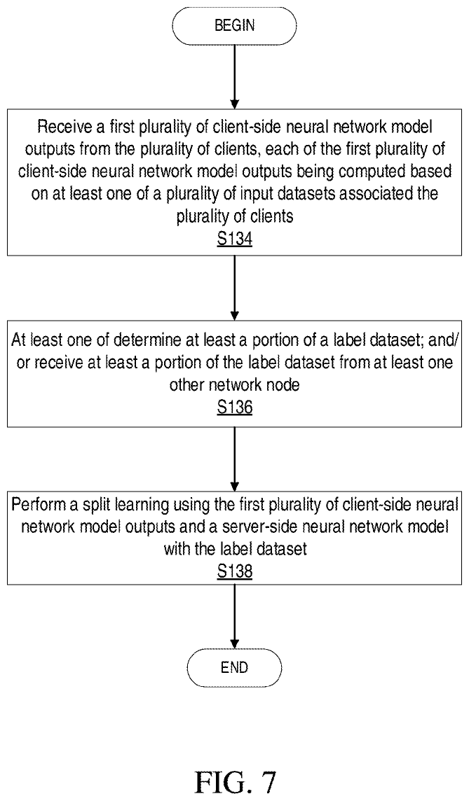

FIG. 7 is a flowchart of an example process in a server network node 16 (e.g., a Service Management and Orchestration, SMO, node) for supporting split learning for sensing-aided beam selection. One or more blocks described herein may be performed by one or more elements of server network node 16 such as by one or more of processing circuitry 68 (including the SMO unit 32), processor 70, radio interface 62 and/or communication interface 60. Server network node 16 is configured to communicate with a plurality of clients (e.g., other network nodes 16 and/or WDs 22), each of the plurality of clients being configured with a client-side neural network model. The server network node 16 is configured to, and/or comprising the radio interface, and/or comprising processing circuitry configured to receive (Block S134) a first plurality of client-side neural network model outputs from the plurality of clients, each of the first plurality of client-side neural network model outputs being computed based on at least one of a plurality of input datasets associated the plurality of clients. The server network node 16 is configured to at least one of (Block S136) determine at least a portion of a label dataset, and/or receive at least a portion of the label dataset from at least one other network node 16 (or other entity in system 10). The server network node 16 is configured to perform (Block S138) a split learning using the first plurality of client-side neural network model outputs and a server-side neural network model with the label dataset.

In some embodiments, performing the split learning includes determining, using the server-side neural network model and the first plurality of client-side neural network model outputs, a first plurality of server-side neural network parameters, transmitting (e.g., directly and/or via one or more intermediate devices such as radio base station network nodes 16) the first plurality of server-side neural network parameters to each of the plurality of clients for further training each client's client-side neural network model, receiving, responsive to transmitting the first plurality of neural network parameters, a second plurality of client-side neural network model outputs from the plurality of clients, each of the second plurality of client-side neural network model outputs being based on at least one of the plurality of input datasets and the first plurality of server-side neural network parameters, and further training the server-side neural network model based on the second plurality of client-side neural network model outputs.

In some embodiments, the server network node 16 is further configured to either perform a beam selection inference for a first WD 22 based on the server-side neural network model, and/or transmit (e.g., directly and/or via one or more intermediate devices such as radio base station network nodes 16) the server-side neural network model to at least one other network node 16 for performing the beam selection inference for the first WD 22 (and/or another WD 22) based on the server-side neural network model. In some embodiments, the first WD 22 is one of the plurality of clients.

In some embodiments, the label dataset corresponds to at least one of millimeter wave, mmWave, data associated with at least one of the plurality of clients (which may or may not include the first WD 22 associated with the beam selection inference), radio measurement data associated with at least one of the plurality of clients, and/or network performance data associated with at least one of the plurality of clients.

In some embodiments, the plurality of input datasets correspond to at least one of camera data associated with at least one of the plurality of clients, LiDAR data associated with at least one of the plurality of clients, and/or GPS data associated with at least one of the plurality of clients.

In some embodiments, a first input dataset of the plurality of input datasets is one of accessible by a first client of the plurality of clients and not accessible by at least one other client of the plurality of clients, or only accessible by the first client of the plurality of clients and not accessible by all other clients of the plurality of clients (and/or not accessible by the server network node 16).

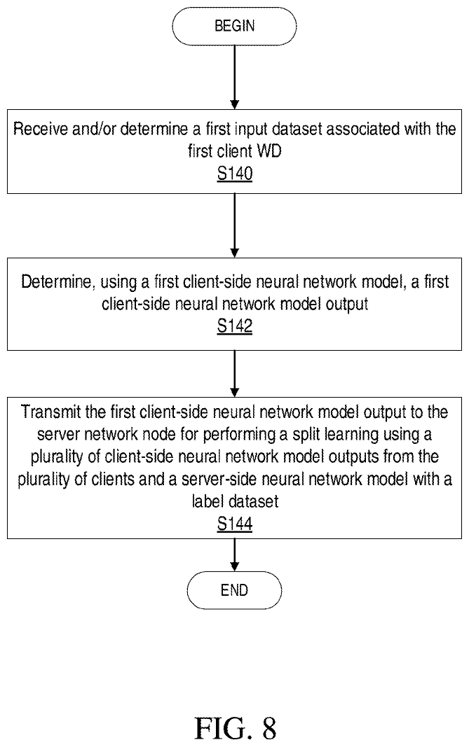

FIG. 8 is a flowchart of an example process in a first client (e.g., a WD 22 or network node 16 or client 35) according to some embodiments of the present for supporting split learning for sensing-aided beam selection. When the first client is a WD 22, one or more blocks described herein may be performed by one or more elements of wireless device 22 such as by one or more of processing circuitry 84 (including the Beamforming unit 34), processor 86, radio interface 82 and/or communication interface 60. When the first client is a network node 16, one or more blocks described herein may be performed by one or more elements of network node 16 such as by one or more of processing circuitry 68 (including the SMO unit 32), processor 70, radio interface 62 and/or communication interface 60. In one or more embodiments, the first client is client 35.

The first client is configured to communicate with a server network node 16 (e.g., a Service Management and Orchestration, SMO, node), the server network node 16 configured to communicate with a plurality of clients (e.g., other network nodes 16 and/or other WDs 22), each of the plurality of clients being configured with a client-side neural network model. The first client is configured to receive and/or determine (Block S140) a first input dataset associated with the first client. The first client is configured to determine (Block S142), using a first client-side neural network model, a first client-side neural network model output (e.g., gradient values, weight values, bias values, model parameters, etc.). The first client is configured to transmit (Block S144) (e.g., directly and/or via one or more intermediate devices such as radio base station network nodes 16) the first client-side neural network model output to the server network node 16 for performing a split learning using a plurality of client-side neural network model outputs from the plurality of clients and a server-side neural network model with a label dataset.

In some embodiments, the first client is further configured to receive, from the server network node 16, responsive to transmitting the first client-side neural network model output, a first plurality of server-side neural network parameters determined based on the first plurality of client-side neural network model outputs including the first client-side neural network model output, further train the first client's client-side neural network model based on the first plurality of server-side neural network parameters, and transmit (e.g., directly and/or via one or more intermediate devices such as radio base station network nodes 16) a second client-side neural network model output to the server network node 16 for further training the server-side neural network model based on a second plurality of client-side neural network model outputs including the second client-side neural network model output.

In some embodiments, when the first client is a first WD 22, the first client is configured to receive a beam selection configuration based on a beam selection inference for the first WD 22 based on the server-side neural network model.

In some embodiments, when the first client is a first network node 16, the first client is configured to determine a beam selection configuration based on a beam selection inference for a first WD 22 and the first network node 16 (e.g., where the first WD is served by the first network node 16) based on the server-side neural network model, and to transmit (e.g., directly and/or via one or more intermediate devices such as radio base station network nodes 16) an indication of the beam selection configuration to the first WD 22.

In some embodiments, the label dataset corresponds to at least one of millimeter wave, mmWave, data associated with at least one of the plurality of clients, radio measurement data associated with at least one of the plurality of clients, and/or network performance data associated with at least one of the plurality of clients.

In some embodiments, the first input dataset corresponds to at least one of camera data associated with at least one of the plurality of clients, LiDAR data associated with at least one of the plurality of clients, and/or GPS data (or equivalent location or coordinates data) associated with at least one of the plurality of clients.

In some embodiments, the first input dataset is either accessible by the first client and not accessible by at least one other client of the plurality of clients, or only accessible the first client and not accessible by all other clients of the plurality of clients (and/or not accessible by the server network node 16).

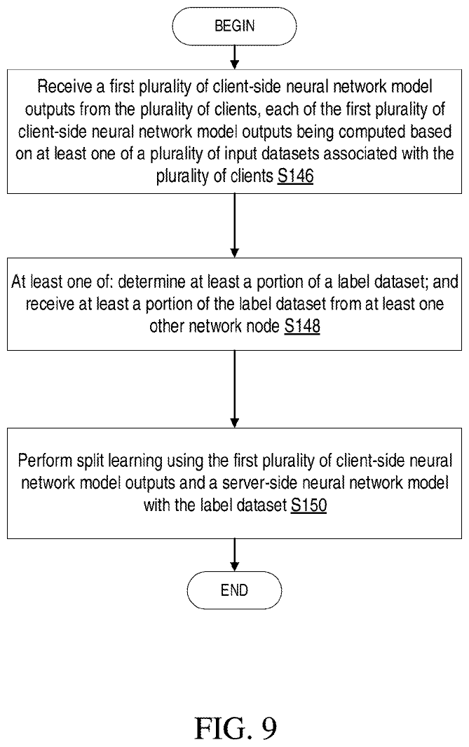

FIG. 9 is a flowchart of another example process in a server network node 16 (e.g., a Service Management and Orchestration, SMO, node) for supporting split learning for sensing-aided beam selection. One or more blocks described herein may be performed by one or more elements of server network node 16 such as by one or more of processing circuitry 68 (including the SMO unit 32), processor 70, radio interface 62 and/or communication interface 60. Server network node 16 is configured to communicate with a plurality of clients (e.g., other network nodes 16 and/or WDs 22 and/or client 35), each of the plurality of clients being configured with a client-side neural network model. The server network node 16 is configured to receive a first plurality of client-side neural network model outputs from the plurality of clients, each of the first plurality of client-side neural network model outputs being computed based on at least one of a plurality of input datasets associated with the plurality of clients (Block S146). Server network node 16 is configured to at least one of: determine at least a portion of a label dataset; and receive at least a portion of the label dataset from at least one other network node. (Block S148). Server network node 16 is configured to perform split learning using the first plurality of client-side neural network model outputs and a server-side neural network model with the label dataset (Block S150).

In some embodiments, performing the split learning comprises: determining, using the server-side neural network model and the first plurality of client-side neural network model outputs, a first plurality of server-side neural network parameters; and transmitting the first plurality of server-side neural network parameters to each of the plurality of clients.

In some embodiments, server network node (16) is further configured to perform a beam selection inference for a first user equipment based on the server-side neural network model.

In some embodiments, the label dataset corresponds to at least one of: millimeter wave, mmWave, data associated with at least one of the plurality of clients; radio measurement data associated with at least one of the plurality of clients; and network performance data associated with at least one of the plurality of clients.

In some embodiments, the plurality of input datasets correspond to at least one of: camera data associated with at least one of the plurality of clients; light detection and ranging, LiDAR, data associated with at least one of the plurality of clients; and global positioning system, GPS, data associated with at least one of the plurality of clients.

In some embodiments, a first input dataset of the plurality of input datasets is one of: accessible by a first client of the plurality of clients and not accessible by at least one other client of the plurality of clients; and only accessible by the first client of the plurality of clients and not accessible by all other clients of the plurality of clients.

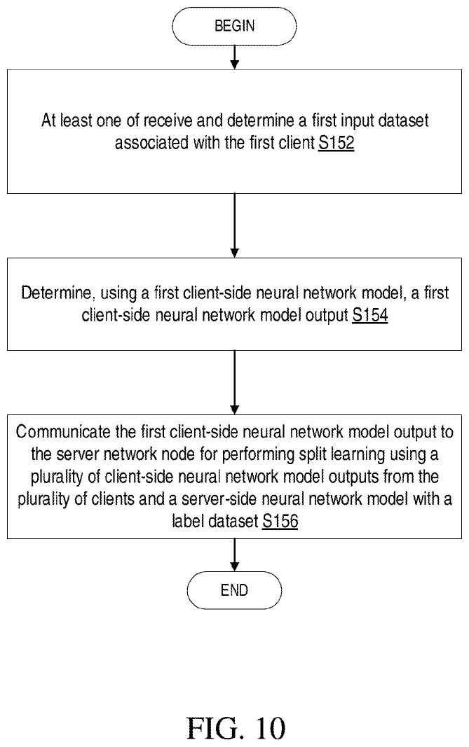

FIG. 10 is a flowchart of another example process in a first client (e.g., a WD 22, network node 16, or client 35) according to some embodiments of the present for supporting split learning for sensing-aided beam selection. When the first client is a WD 22, one or more blocks described herein may be performed by one or more elements of wireless device 22 such as by one or more of processing circuitry 84 (including the Beamforming unit 34), processor 86, radio interface 82 and/or communication interface 60. When the first client is a network node 16, one or more blocks described herein may be performed by one or more elements of network node 16 such as by one or more of processing circuitry 68 (including the SMO unit 32), processor 70, radio interface 62 and/or communication interface 60. In one or more embodiments, first client is client 35.

The first client is configured to communicate with a server network node 16 (e.g., a Service Management and Orchestration, SMO, node), the server network node 16 configured to communicate with a plurality of clients (e.g., other network nodes 16 and/or other WDs 22), each of the plurality of clients being configured with a client-side neural network model. The first client is configured to at least one of receive and determine a first input dataset associated with the first client (Block S152). The first client is configured to determine, using a first client-side neural network model, a first client-side neural network model output (Block S154). The first client is configured to communicate the first client-side neural network model output to the server network node for performing split learning using a plurality of client-side neural network model outputs from the plurality of clients and a server-side neural network model with a label dataset (Block S156).

In some embodiments, first client is further configured to: based on the first client being a first user equipment (22), receive a beam selection configuration based on a beam selection inference for the first user equipment (22) based on the server-side neural network model.

In some embodiments, first client of is further configured to: based on the first client being a first network node (16), determine a beam selection configuration based on a beam selection inference for a first user equipment and the first network node (16) based on the server-side neural network model; and transmit an indication of the beam selection configuration to the first user equipment.

In some embodiments, the label dataset corresponds to at least one of: millimeter wave, mmWave, data associated with at least one of the plurality of clients; radio measurement data associated with at least one of the plurality of clients; and network performance data associated with at least one of the plurality of clients.

In some embodiments, the first input dataset corresponds to at least one of: camera data associated with at least one of the plurality of clients; LiDAR data associated with at least one of the plurality of clients; and GPS data associated with at least one of the plurality of clients.

In some embodiments, the first input dataset is one of: accessible by the first client and not accessible by at least one other client of the plurality of clients; only accessible the first client and not accessible by all other clients of the plurality of clients.

Having described the general process flow of arrangements of the disclosure and having provided examples of hardware and software arrangements for implementing the processes and functions of the disclosure, the sections below provide details and examples of arrangements for supporting split learning for sensing-aided beam selection.

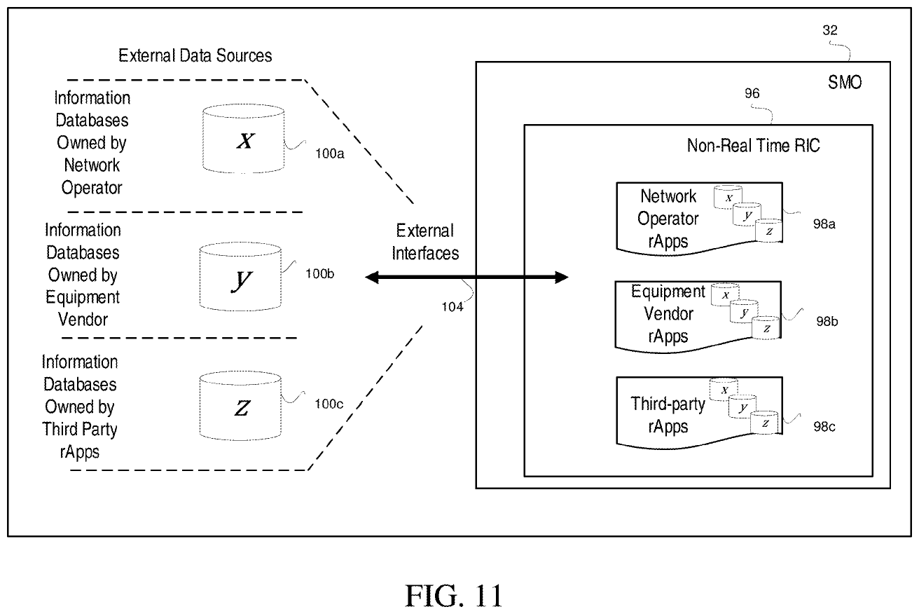

FIG. 11 is a diagram which illustrates an example architecture and process flow for an example open and multi-vendor disaggregated RAN environment according to some embodiments of the present disclosure. In the example of FIG. 11, an open and multi-vendor disaggregated RAN environment is depicted, featuring multi-external data sources and multi-applications. Data sources may be maintained by different entities (e.g., network operator, equipment vendor, third party rApp developers, etc.), and the architecture may enable multiple RAN applications.

A Service Management and Orchestration (SMO) unit 32 (e.g., implemented in a network node 16, host computer 24, cloud node, etc.) may be responsible for managing and coordinating various network functions, resources, and services, as well as providing a platform for the execution of applications that enhance network performance and user experience. A non-real time Radio Intelligent Controller (RIC) 96 may be a component within the SMO architecture (e.g., a subcomponent of SMO unit 32, and/or another unit/component running on processing circuitry 42 or processing circuitry 84, for example), designed to provide control and optimization functions for the radio access network (RAN) using, e.g., advanced analytics and machine learning techniques.

The non-real time RIC 96 may be configured to host and manage a diverse set of RAN applications, known as rAPPs 98, which may be developed and provided by network operators, equipment vendors, and third-party developers. These rAPPs 98 may be configure to optimize/manage various aspects of the network, such as resource allocation, traffic management, interference mitigation, and network slicing, among others.

For network operator rAPPs 98a, the non-real time RIC offers a platform that enables operators to develop and deploy their custom applications tailored to their specific network requirements and strategies. These applications may include optimization algorithms for efficient spectrum utilization, energy savings, or network maintenance, for example. The network operator(s) may own information databases 100a including data associated with the network operator rAPPs 98a. As used herein, “own” in the context of data may refer to data being restricted (e.g., for regulatory/legal purposes, privacy purposes, intellectual property purposes, etc.), such that one or more entities in system 10 may have access to read or manipulate such data, while other entities in system 10 may not have access to read or manipulate such data.

Equipment vendor rAPPs 98b may be configured by original equipment manufacturers (OEMs) to optimize the performance of their specific hardware and software systems within the 5G network. These rAPPs may include functions for enhancing the capabilities of base stations, antennas, and other network components, for example. The equipment vendor(s) may own information databases 100b including data associated with the equipment vendor rAPPs 98b.

Third-party rAPPs 98c may be developed by independent software vendors, providing an additional layer of innovation and customization to the non-real time RIC ecosystem. These applications can offer new features, services, or optimizations that were not initially considered by the network operators or equipment vendors. By supporting third-party rAPPs 98c, the non-real time RIC allows for the introduction of novel solutions and enables the continuous evolution of the 5G network to meet emerging demands and use cases. The third-party app vendors may own the information databases 100c including data associated with the third-party rAPPs 98c.

Each of the rAPPs 98 may communicate with one or more databases 100 via one or more external interface(s) 104. As noted above, access to one or more databases 100 may be restricted such that only certain entities in system 10 may read or otherwise interact with the data stored therein.

In some embodiments, the use of data-driven methods for intelligent optimization through RAN applications may, for example, leverage the importance of internal and external databases. Such databases may store contextual information acquired by sensing operations and support multiple network functions, e.g., beam selection, mobility management, and traffic steering. The environment may also be heterogeneous in terms of application developers and databases maintainers. Applications developed by the network operator, the equipment vendor and third-party enterprises may be configured to work together and may be configurable for leveraging the same data sources.

Multi-external data sources and multi-applications RAN environment may be subject to new challenges, such as:
Privacy: Some data sources may carry sensitive information (e.g., user location and camera images), which should be carefully processed.
Data Ownership: Data is treated as an asset. In a multi-vendor RAN, it could impose constraints on the sharing of raw data with third-party applications and platforms.
Performance: The sharing of high-volume data with multiple applications could overload communication and processing within the management and orchestration platform.

Embodiments of the present disclosure may support applications based on Neural Networks (NN) that are enabled by multiple data sources in an open and multi-vendor disaggregated RAN environment, e.g., through the use of Split Learning (SL), which may address the above privacy, data ownership, and performance requirements of such an environment.

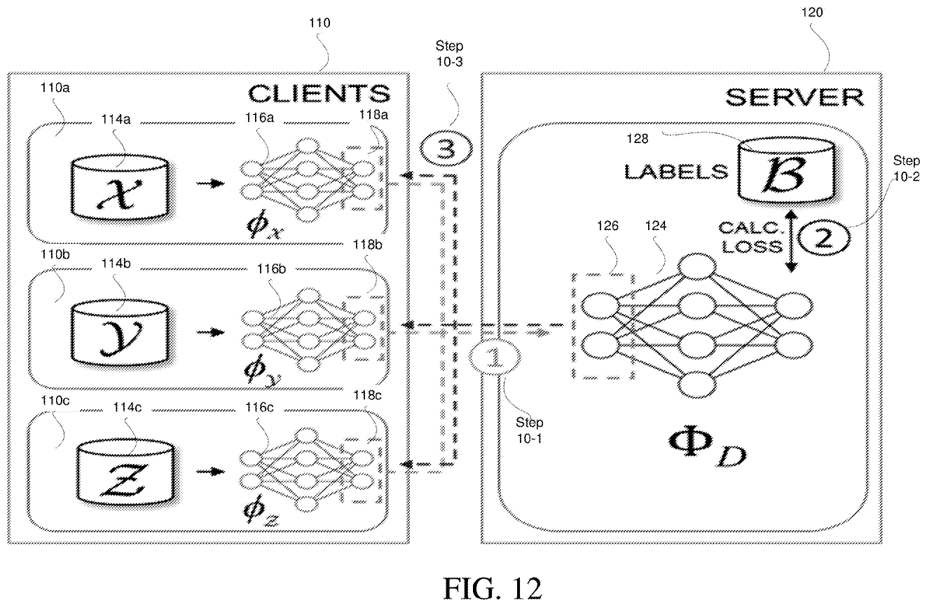

FIG. 12 depicts an example Split Learning (SL) framework over a vertically partitioned data architecture, according to some embodiments of the present disclosure. Clients 110 (here, three example clients 110a, 110b, and 110c are illustrated, but more clients 110 may be included) may be configured for performing neural network operations for split learning. In one or more embodiments, one or more of clients 110a-c corresponds to and/or comprises client 35. Client 110a may feed dataset 114a (“x” dataset) as an input to neural network model 116a, including output layer 118a. Client 110b may feed dataset 114b (“y” dataset) as an input to neural network model 116b, including output layer 118b. Client 110c may feed dataset 114c (“z” dataset) as an input to neural network model 116c, including output layer 118c. The clients 110a, 110b, 110c, etc., may be referred to collectively as clients 110. The datasets 114a, 114b, 114c, etc., may be referred to collectively as datasets 114. The neural network models 116a, 116b, 116c, etc., may be referred to collectively as client-side neural network models 116. The last layers 118a, 118b, 118c, etc., may be referred to collectively as last layers 118. Clients 110 may refer to one or more entities of system 10 such as network nodes 16, WDs 22, clients 35, etc. Clients 110 may be configured to communicate with server 120 (e.g., a network node 16, a host computer 24, etc.) for spilt learning.

Referring still to FIG. 12, in Step 10-1, the “Forward” step, outputs (e.g., gradient values, weight values, bias values, other parameters, etc.) from the neurons in the clients' 110 neural networks models' 116 last layers 118 may be concatenated (e.g., by server 120) and fed into the server's 120 server-side neural network model 124, for example, starting with the first layer 126. In Step 10-2, loss is computed at the server 120 side, which may have access to the labels dataset 128. In Step 10-3, the “Backward” step, gradients are propagated, e.g., from the server's 120 first layer 126, to the clients' 110 last layers 118. In some embodiments, the labels dataset 128 may only be accessible to some entities in system 10, such as the server 120 (implemented, e.g., by a network node 16, host computer 24, etc.). In some embodiments, some portions of the labels dataset 128 may be accessible to some entities, but not other portions. Thus, in some embodiments, server 120 may be enabled for split learning where server 120 has access to the labels dataset 128, while clients 110 may not have such access. Similarly, clients 110 may have access to one or more corresponding datasets 114, whereas server 120 may not have access to some or all of the datasets 114.

For example, in some embodiments, the following steps as illustrated in FIG. 12 may be performed:

Step 1—The Forward Step: In this step, the neural network models 116 running on the clients 110 (e.g., network nodes 16, WDs 22, client 35 etc.) complete their forward pass based in part on inputs (i.e., datasets) 114. The outputs from the neurons in the last layers 118 of the neural network models 116 clients 110 are collected and concatenated. The server 120 (e.g., a server network node 16, a host computer 24, etc.) receives these concatenated outputs and feeds them into its server-side neural network model 124, specifically at the first layer 126. A purpose of this step is to combine the local computations performed by each client's 110 neural network model 116 into a global representation at the server 120 level, while, in at least some cases, avoiding the need to share restricted/private/sensitive datasets between clients 110 and/or server 120 and/or other entities in system 10.

Step 2—Computing Loss: Once the server's neural network model 124 has processed the concatenated outputs from the clients, it computes the loss using the provided (ground truth) labels datasets 128. This loss computation is a notable part of the training process, as it quantifies how well the current model is performing in terms of predicting the correct outputs. Based on this loss value, the model may be adjusted during the next step.

Step 3—The Backward Step: After the loss has been computed, the server 120 begins the backward pass, which involves calculating gradients for each layer in its server-side neural network model 124, starting from the first layer 126. These gradients represent how much the weights and biases of the server-side neural network model 124 may be updated to minimize the loss. Once the gradients are calculated for the server's 120 neural network model 124, they are propagated back to the clients' 110 last layers 118. The clients 110 can then continue the backward pass for their client-side neural network models 124, ultimately updating their weights and biases based on the received gradients.

As an example, consider the features databases X, Y and Z, the labels database B, and a model f_{D}(xₜ, yₜ, zₜ, φ_{X}, φ_{Y}, φ_{Z}, Φ_{D}), which represents a RAN application, where xₜ, yₜ, zₜ are samples from the databases X, Y and Z, and φ_{X}, φ_{Y}, φ_{Z}, Φ_{D} are four sets of NN parameters. In SL, a set of clients 110 (e.g., network nodes 16, WDs 22, client 35, etc.) responsible for (e.g., owning) the datasets 114 and a server 120 (e.g., a host computer 24, (server) network node 16, etc.) responsible for an application (e.g., a beamforming configuration application) may be configured. Each client 110, for example, may hold and train a portion of a NN (e.g., client-side neural network models 116), as does the server 120 (e.g., server-side neural network model 124). During the forward step in the training process, the outputs from the neurons in the client's 110 last layer (named a “cut” layer in SL) may be concatenated and fed into the server's 120 first layer. A loss function may be computed at the server 120 side, which may have access to the labels dataset 128 (in this case, B). An inverse procedure may occur to propagate the gradients and update the parameters in the backward step. For example, øx, Øy and Øz may be the model parameters for the clients 110 holding X, Y and Z and running fp. OD may refer to the set of model parameters on the server 120 side for this example application.

### Multi-Modal Sensing-Aided Beam Selection Based on Split Learning

Some embodiments described herein may use an SL framework to enable multi-modal sensing-aided beam selection in a multi-vendor disaggregated RAN environment. A goal of a multi-modal sensing-aided beam selection method based on ML is to map contextual information inputs to an optimal beam decision. Contextual information inputs may be leveraged by sensing operations and stored at external data sources, in some embodiments. Some examples of contextual data that may be used to support beam selection are user location, camera images, radar and LiDAR data, for instance.

For example, consider a beam selection decision to be performed in a codebook with N_{B} beams, and the availability of multi-modal sensing databases X, Y and Z, which are sampled at each time t E T. Consider that the power gain values of each beam in the codebook obtained from exhaustive search beam sweeping operations over T are stored, and the optimal beam at t may be defined as

$${I}_{t} = arg max ( {b}_{t} [ i ] )$$

$$i ∈ [ 1 , {N}_{B} ]$$

where bₜ[i] is the received power from the ith beam at t. For sample labeling purposes, it can be encoded as the one-hot vector

$${b}_{t}^{′} ∈ {\{ 0 , 1 \}}^{N B} , {b}_{t}^{′} = {\{ {b}_{t}^{′} [ i ] \}}_{i ∈ [ 1 , NB ]} ,$$

where b′ₜ[i]=1 only when i=Iₜ. A database B={b′ₜ}_{t∈T} may then be used to store the labels required in the training of the proposed model. Embodiments of the present disclosure may leverage a model f_{D}, so as:

$${f}_{D} ( {x}_{t} , {y}_{t} , {z}_{t} , {ϕ}_{X} , {ϕ}_{Y} , {ϕ}_{Z} , {Φ}_{D} ) := {p}_{D , t}$$

f_{D} is an SL model that takes xₜ, yₜ, zₜ as samples from the databases X, Y and Z, and φ_{X}, φ_{Y}, φ_{Z}, Φ_{D} as four sets of NN parameters. p_{D,t} is a probability vector comprising the full codebook, then:

$${p}_{D , t} = {\{ {p}_{D , t} [ i ] \}}_{i ∈ [ 1 , N B ]}$$

p_{D,t}[i] is the probability of the beam i being the optimal beam at the time t, assigned by the model f_{D}. The model output may have size N_{B}. Taking K_{D,t,k} as the vector corresponding to the k most likely beam indices from the model output p_{D,t}, the measurements set M_{D,t,k} may be define as:

$${M}_{D , t , k} = {\{ {b}_{t} [ i ] \}}_{i ∈ KD , t , k} .$$

Moreover, building M_{D,t,k}|M_{D,t,k}|=k, represents applying beam sweeping over the k most likely beams. If k<<N_{B}, relevant gains from overhead savings are still verified. Finally, the prediction of the optimal beam may be taken from:

$${\hat{I}}_{t} = arg max ( {b}_{t} [ i ] )$$

$$i ∈ {K}_{D , t , k}$$

### Sensing Information Sources

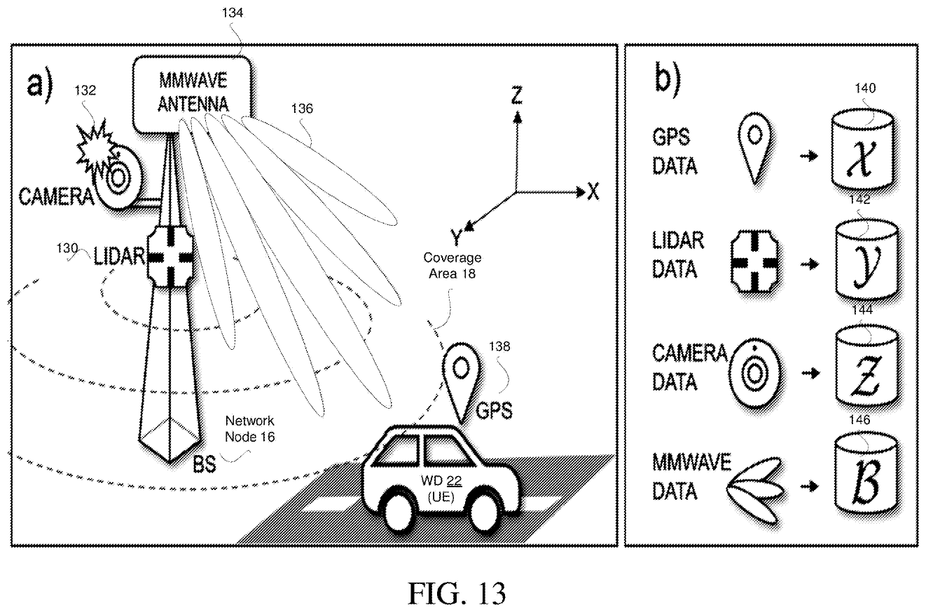

FIG. 13 is an example architecture and process flow diagram which illustrates an example sensing and mmWave data collection process according to some embodiments of the present disclosure, and illustrates an example use case of sensing and mmWave information as databases to support beam selection.

In particular, FIG. 13 illustrates a network node 16, such as a base station (BS), in communication with a wireless device 22, for example, a vehicle, within a coverage area 18. The network node 16 is equipped with and/or in communication with a variety of sensing and communication devices, including a LIDAR device 130, a camera 132, and a millimeter wave (mmWave) antenna 134 associated with multiple beams 136. The wireless device 22 may be outfitted with a GPS 138, integrated within radio interface 82, processing circuitry 84, or other related components, for example. As a result, there may be GPS data 140 (“x”), LIDAR data 142 (“y”), camera data 144 (“z”), and/or mmWave data 146 (“B”) associated with the WD 22 and/or network node 16.

In some embodiments, these data sources may be utilized to support beam selection decision-making. By combining the information from GPS data 140, LIDAR data 142, camera data 144, and/or mmWave data 146, the system may make more informed decisions about the most appropriate beam to use for communication between the network node 16 and the wireless device 22. This may lead to improved communication quality, enhanced network efficiency, and better overall performance.

There may be privacy and data ownership concerns associated with these various data sources. Given that data may originate from different vendors or owners, and may be subject to diverse privacy or regulatory requirements, which may be addressed by the split-learning techniques described herein. In other words, there may be restrictions on transferring data from a first client 110 (e.g., a network node 16, wireless device 22, and/or client 35) to another client 110, or to server 120 or other entity in system 10, and embodiments of the present disclosure may avoid such transferring of data by instead performing split-learning, e.g., by communicating client-side neural network model 116 outputs, rather than communicating the (restricted) data on which the outputs are based.

Note that, in this case, GPS data 140 may provide awareness of user position, but other location methods/data may be used and deliver similar value, without deviating from the scope of the present disclosure. LiDAR information and camera images may be shown as examples of sensing data that may describe the scenario/environment and which may support beam selection decision-making. Similarly, other data types/data sources/etc. may be used in this task. In the case of a multi-vendor RAN environment, for example, each sensing operation and database may be maintained by a different enterprise (e.g., network operator, equipment vendor, third-party rApp developer, etc.). Databases storing contextual information gathered with other ends (e.g., camera images from security footage) may also be exploited, thus, the need to account for privacy and data ownership in many cases.

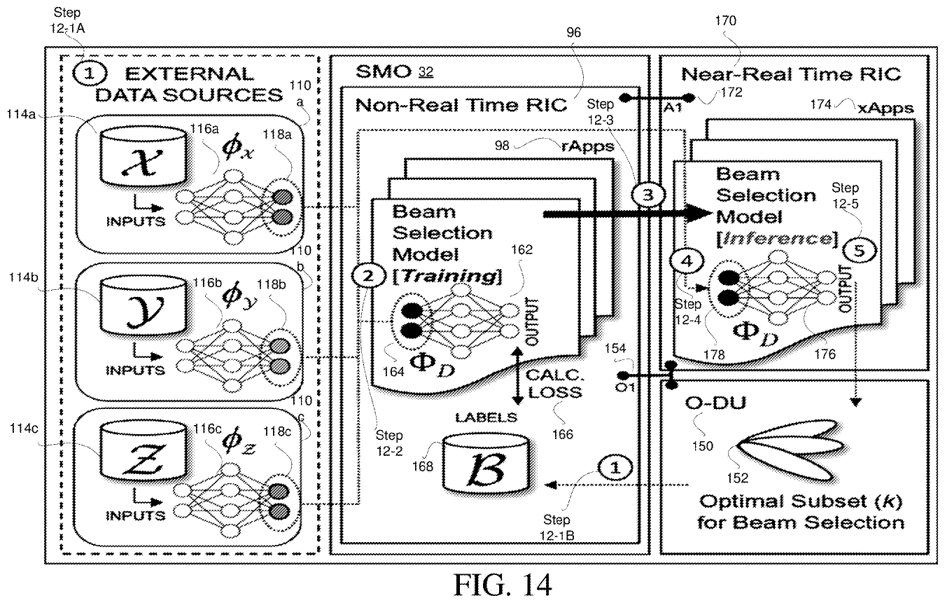

The Open RAN Alliance (O-RAN) defines the AI/ML-assisted Beam Selection Optimization as one of its main massive MIMO-related use cases. It foresees the use of contextual information stored at external data sources, which may be fed by sensing operations. The distributed nature of learning in split learning (SL) may enable embodiments described herein to be suitable for O-RAN architecture. The integration of this sensing-aided SL-based beam selection method and O-RAN architecture is conceptually depicted in FIG. 14.

FIG. 14 is an architecture and process flow diagram which illustrates an example integration of multi-modal sensing-aided SL embodiments described herein for beam selection in an O-RAN architecture, e.g., for an AI/ML-assisted Beam Selection Optimization use case. In FIG. 14, clients 110 (e.g., network nodes 16, WDs 22, clients 35, etc.) communicate with SMO unit 32 (e.g., which may be implemented in one or more of a server 120, host computer 24, cloud node, core node, virtual node, (server) network node 16, etc.). The Non-Real Time RIC may have a plurality of associated rApps 98. The SMO unit 32 may be configured to communicate with an O-DU 150, e.g., via O1 interface 154, and with a near-real time RIC 170, e.g., via an A1 interface 172, where the near-real time RIC 170 may be, e.g., implemented in one or more of a server 120, host computer 24, cloud node, core node, virtual node, network node 16, etc. The near-real time RIC 170 may be configured to operate one or more xApps 174.

Referring to FIG. 14, in Step 12-1, a data collection is performed including sensing information stored on external data sources (e.g., datasets 114a, 114b, 114c, etc. associated with clients 110a, 110b, 110c, etc.) and mmWave data (e.g., dataset 168) acquired from an Open Distributed Unit (O-DU) 150, for example. In Step 12-2, a training is performed, including an SL training phase being performed at the external data sources (e.g., clients 110a, 110b, 110c, etc., train the neural network models 116a, 116b, 116c, etc., which each have an output layer 118a, 118b, 118c, etc.) and Non-Real Time RAN Intelligent Controller (RIC) 96 (e.g., neural network model 162 with input layer 164). Outputs may be shared between clients 110 (e.g., network nodes 16, WDs 22, clients 35, etc.) and server 120 (e.g., host computer 24, (server) network node 16, etc.), e.g., via the Service Management and Orchestration (SMO) unit 32. The loss value is calculated based on the labels dataset 168, and used to adjust the gradients, weight values, biases, etc., as described herein. In Step 12-3, a deployment is performed, including the trained application (e.g., server 120 side) being deployed in the Near-Real Time RIC 170. In Step 12-4, an inference is performed, e.g., for new sensing information, data may be applied to clients 110, and the clients' 110 outputs may be sent to the application deployed at the Near-Real Time RIC 170 for inference, e.g., using neural network model 176 with input layer 178. In Step 12-5, the output of the beam selection model (inference) process may be provided to the O-DU 150 or another entity, which may utilize the information to determine an optimal subset (k) for beam selection. Thus, an action may be taken, e.g., the optimal beam or subset is applied to O-DU (network node 16), based on inference of the trained ML model.

For example, in some embodiments, a method may be performed (e.g., by one or more of a WD 22, network node 16, host computer 24, client 110, server 120, etc.) as follows:

Step 12-1: Data Collection—Data may be obtained from various sources, such as external data sources (e.g., datasets 114a, 114b, 114c, etc., associated with clients 110a, 110b, 110c, etc.) and millimeter-wave (mmWave) data (e.g., dataset 168) acquired from an Open Distributed Unit (O-DU) 150 (e.g., a network node 16 operating as and/or including an O-DU). In some embodiments, the mmWave data may be collected elsewhere, e.g., from an O-CU, from another type of network node 16, etc. The mmWave data may be used to generate the labels dataset 168, which is used to confirm the accuracy of the model during training. In some embodiments, other types of data may be collected other than mmWave data (e.g., radio signal measurements, network performance metrics, etc.) and/or may be collected from other entities in the communication system 10 (e.g., a WD 22, a host computer 24, etc.), without deviating from the scope of the present disclosure. The data may be restricted, e.g., owned by a first client 110 and not accessible to (at least one) other clients 110 and/or server 120.

Step 12-2: Training Phase—Clients 110 (e.g., WDs 22, network nodes 16, clients 35, etc.) execute a split learning training phase (e.g., as described herein, such as with respect to FIG. 12) at the external data sources (e.g., clients 110a, 110b, 110c, etc., train the neural network models 116a, 116b, 116c, etc., which each have an output layer 118a, 118b, 118c, etc.) and at the SMO unit 32/Non-Real Time RAN Intelligent Controller (RIC) 96 (e.g., neural network model 162 with input layer 164). In some embodiments, the neural network model outputs may be shared between clients 110 (e.g., network nodes 16, WDs 22, clients 35, etc.) and server 120 (e.g., host computer 24, (server) network node 16, etc.), e.g., via the Service Management and Orchestration (SMO) unit 32/non-real time RIC 96. The loss value may be calculated based on the labels dataset 168 and used to adjust the gradients, weight values, biases, etc., as described herein. In the example of FIG. 14, the server 120 of FIG. 12 may correspond to one or more of the SMO unit 32, the non-real time RIC 96, etc.

Step 12-3: Deployment—The trained neural network model(s) and/or applications are deployed, e.g., in a Near-Real Time RIC 170, which may be implemented in any of a network node 16, host computer 24, cloud node, etc.

Step 12-4: Inference—An inference is performed on new sensing information (e.g., new/updated/additional/real-time datasets 114). (New) data may be applied to clients 110, and the clients' 110 client-side neural network model 116 outputs may be sent to the application deployed at the Near-Real Time RIC 170 for inference, e.g., using trained neural network model 176 with input layer 178.

Step 12-5: Beam Selection Model Output—the beam selection model (inference) process outputs are provided to the O-DU 150 or another entity, which may utilize the information to determine an optimal beam and/or subset (k) for beam selection. Consequently, an action may be taken, e.g., the optimal beam or subset is applied to a network entity, e.g., O-DU 150, a network node 16, a WD 22, client 35, etc., based on inference of the trained ML model.

### Examples

Example A1. A server network node 16 (e.g., a Service Management and Orchestration, SMO, node) configured to communicate with a plurality of clients (e.g., other network nodes and/or WDs), each of the plurality of clients being configured with a client-side neural network model, the server network node 16 configured to, and/or comprising the radio interface, and/or comprising processing circuitry configured to:
receive a first plurality of client-side neural network model outputs from the plurality of clients, each of the first plurality of client-side neural network model outputs being computed based on at least one of a plurality of input datasets associated the plurality of clients;
at least one of:
   determine at least a portion of a label dataset; and/or
   receive at least a portion of the label dataset from at least one other network node; and
perform a split learning using the first plurality of client-side neural network model outputs and a server-side neural network model with the label dataset.

Example A2. The server network node 16 of Example A1, wherein performing the split learning includes:
determining, using the server-side neural network model and the first plurality of client-side neural network model outputs, a first plurality of server-side neural network parameters;
transmitting the first plurality of server-side neural network parameters to each of the plurality of clients for further training each client's client-side neural network model; and
receiving, responsive to transmitting the first plurality of neural network parameters, a second plurality of client-side neural network model outputs from the plurality of clients, each of the second plurality of client-side neural network model outputs being based on at least one of the plurality of input datasets and the first plurality of server-side neural network parameters; and
further training the server-side neural network model based on the second plurality of client-side neural network model outputs.

Example A3. The server network node 16 of any one of Examples A1 and A2, wherein the server network node 16 and/or a radio interface and/or processing circuitry is further configured to at least one of:
perform a beam selection inference for a first WD based on the server-side neural network model; and/or
transmit the server-side neural network model to at least one other network node for performing the beam selection inference for the first WD based on the server-side neural network model.

Example A4. The server network node 16 of Example A3, wherein the first WD is one of the plurality of clients.

Example A5. The server network node 16 of any one of Examples A1-A4, wherein the label dataset corresponds to at least one of:
millimeter wave, mmWave, data associated with at least one of the plurality of clients;
radio measurement data associated with at least one of the plurality of clients; and/or
network performance data associated with at least one of the plurality of clients.

Example A6. The server network node 16 of any one of Examples A1-A5, wherein the plurality of input datasets correspond to at least one of:
camera data associated with at least one of the plurality of clients;
LiDAR data associated with at least one of the plurality of clients; and/or
GPS data associated with at least one of the plurality of clients.

Example A7. The server network node 16 of any one of Examples A1-A6, wherein a first input dataset of the plurality of input datasets is one of:
accessible by a first client of the plurality of clients and not accessible by at least one other client of the plurality of clients;
only accessible by the first client of the plurality of clients and not accessible by all other clients of the plurality of clients.

Example B1. A method implemented in server network node 16 (e.g., a Service Management and Orchestration, SMO, node) configured to communicate with a plurality of clients (e.g., other network nodes and/or WDs), each of the plurality of clients being configured with a client-side neural network model, the method comprising:
receiving a first plurality of client-side neural network model outputs from the plurality of clients, each of the first plurality of client-side neural network model outputs being computed based on at least one of a plurality of input datasets associated the plurality of clients;
at least one of:
   determining at least a portion of a label dataset; and/or
   receiving at least a portion of the label dataset from at least one other network node; and
performing a split learning using the first plurality of client-side neural network model outputs and a server-side neural network model with the label dataset.

Example B2. The method of Example B1, wherein performing the split learning includes:
determining, using the server-side neural network model and the first plurality of client-side neural network model outputs, a first plurality of server-side neural network parameters;
transmitting the first plurality of server-side neural network parameters to each of the plurality of clients for further training each client's client-side neural network model; and
receiving, responsive to transmitting the first plurality of neural network parameters, a second plurality of client-side neural network model outputs from the plurality of clients, each of the second plurality of client-side neural network model outputs being based on at least one of the plurality of input datasets and the first plurality of server-side neural network parameters; and
further training the server-side neural network model based on the second plurality of client-side neural network model outputs.

Example B3. The method of any one of Examples B1 and B2, wherein the method further comprises:
performing a beam selection inference for a first WD based on the server-side neural network model; and/or
transmitting the server-side neural network model to at least one other network node for performing the beam selection inference for the first WD based on the server-side neural network model.

Example B4. The method of Example B3, wherein the first WD is one of the plurality of clients.

Example B5. The method of any one of Examples B1-B4, wherein the label dataset corresponds to at least one of:
millimeter wave, mmWave, data associated with at least one of the plurality of clients;
radio measurement data associated with at least one of the plurality of clients; and/or
network performance data associated with at least one of the plurality of clients.

Example B6. The method of any one of Examples B1-B5, wherein the plurality of input datasets correspond to at least one of:
camera data associated with at least one of the plurality of clients;
LiDAR data associated with at least one of the plurality of clients; and/or
GPS data associated with at least one of the plurality of clients.

Example B7. The method of any one of Examples B1-B6, wherein a first input dataset of the plurality of input datasets is one of:
accessible by a first client of the plurality of clients and not accessible by at least one other client of the plurality of clients;
only accessible by the first client of the plurality of clients and not accessible by all other clients of the plurality of clients.

Example C1. A first client (e.g., a network node or wireless device (WD) or client) configured to communicate with a server network node 16 (e.g., a Service Management and Orchestration, SMO, node), the server network node 16 configured to communicate with a plurality of clients (e.g., other network nodes and/or other WDs), each of the plurality of clients being configured with a client-side neural network model, the first client configured to, and/or comprising a radio interface, and/or comprising processing circuitry configured to:
receive and/or determine a first input dataset associated with the first client;
determine, using a first client-side neural network model, a first client-side neural network model output; and
transmit the first client-side neural network model output to the server network node 16 for performing a split learning using a plurality of client-side neural network model outputs from the plurality of clients and a server-side neural network model with a label dataset.

Example C2. The first client of Example C1, wherein the first client and/or the radio interface and/or processing circuitry is further configured to at least one of:
receive, from the server network node 16, responsive to transmitting the first client-side neural network model output, a first plurality of server-side neural network parameters determined based on the first plurality of client-side neural network model outputs including the first client-side neural network model output;
further train the first client's client-side neural network model based on the first plurality of server-side neural network parameters; and
transmit a second client-side neural network model output to the server network node 16 for further training the server-side neural network model based on a second plurality of client-side neural network model outputs including the second client-side neural network model output.

Example C3. The first client of any one of Examples C1 and C2, wherein the first client and/or the radio interface and/or processing circuitry is further configured to at least one of:
when the first client is a first WD, receive a beam selection configuration based on a beam selection inference for the first WD based on the server-side neural network model.

Example C4. The first client of any one of Examples C1-C3, wherein the first client and/or the radio interface and/or processing circuitry is further configured to at least one of:
when the first client is a first network node, determine a beam selection configuration based on a beam selection inference for a first WD and the first network node based on the server-side neural network model; and
transmit an indication of the beam selection configuration to the first WD.

Example C5. The first client of any one of Examples C1-C4, wherein the label dataset corresponds to at least one of:
millimeter wave, mmWave, data associated with at least one of the plurality of clients;
radio measurement data associated with at least one of the plurality of clients; and/or
network performance data associated with at least one of the plurality of clients.

Example C6. The first client of any one of Examples C1-C5, wherein the first input dataset corresponds to at least one of:
camera data associated with at least one of the plurality of clients;
LiDAR data associated with at least one of the plurality of clients; and/or
GPS data associated with at least one of the plurality of clients.

Example C7. The first client of any one of Examples C1-C6, wherein the first input dataset is one of:
accessible by the first client and not accessible by at least one other client of the plurality of clients;
only accessible the first client and not accessible by all other clients of the plurality of clients.

Example D1. A method implemented in first client (e.g., a network node or wireless device (WD) or client) configured to communicate with a server network node 16 (e.g., a Service Management and Orchestration, SMO, node), the server network node 16 configured to communicate with a plurality of clients (e.g., other network nodes and/or other WDs), each of the plurality of clients being configured with a client-side neural network model, the method comprising:
receiving and/or determining a first input dataset associated with the first client;
determining, using a first client-side neural network model, a first client-side neural network model output; and
transmitting the first client-side neural network model output to the server network node 16 for performing a split learning using a plurality of client-side neural network model outputs from the plurality of clients and a server-side neural network model with a label dataset.

Example D2. The method of Example D1, wherein the method further comprises: receiving, from the server network node 16, responsive to transmitting the first client-side neural network model output, a first plurality of server-side neural network parameters determined based on the first plurality of client-side neural network model outputs including the first client-side neural network model output;
further training the first client's client-side neural network model based on the first plurality of server-side neural network parameters; and
transmitting a second client-side neural network model output to the server network node 16 for further training the server-side neural network model based on a second plurality of client-side neural network model outputs including the second client-side neural network model output.

Example D3. The method of any one of Examples D1 and D2, wherein the method further comprises:
when the first client is a first WD, receiving a beam selection configuration based on a beam selection inference for the first WD based on the server-side neural network model.

Example D4. The method of any one of Examples D1-D3, wherein the method further comprises:
when the first client is a first network node, determining a beam selection configuration based on a beam selection inference for a first WD and the first network node based on the server-side neural network model; and
transmitting an indication of the beam selection configuration to the first WD.

Example D5. The method of any one of Examples D1-D4, wherein the label dataset corresponds to at least one of:
millimeter wave, mmWave, data associated with at least one of the plurality of clients;
radio measurement data associated with at least one of the plurality of clients; and/or
network performance data associated with at least one of the plurality of clients.

Example D6. The method of any one of Examples D1-D5, wherein the first input dataset corresponds to at least one of:
camera data associated with at least one of the plurality of clients;
LiDAR data associated with at least one of the plurality of clients; and/or
GPS data associated with at least one of the plurality of clients.

Example D7. The method of any one of Examples D1-D6, wherein the first input dataset is one of:
accessible by the first client and not accessible by at least one other client of the plurality of clients;
only accessible the first client and not accessible by all other clients of the plurality of clients.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
ML Machine Learning
RAN Radio Access Networks
RIC Ran Intelligent Controller
SL Split Learning
SMO Service Management and Orchestration

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method performed by a server network node configured to communicate with a plurality of clients, each of the plurality of clients being configured with a client-side neural network model, the method comprising:
receiving a first plurality of client-side neural network model outputs from the plurality of clients, each of the first plurality of client-side neural network model outputs being computed based on at least one of a plurality of input datasets associated with the plurality of clients;
at least one of:
determining at least a portion of a label dataset; and
receiving at least a portion of the label dataset from at least one other network node; and
performing split learning using the first plurality of client-side neural network model outputs and a server-side neural network model with the label dataset.

2. The method of claim 1, wherein performing the split learning comprises:
determining, using the server-side neural network model and the first plurality of client-side neural network model outputs, a first plurality of server-side neural network parameters; and
transmitting the first plurality of server-side neural network parameters to each of the plurality of clients.

3. The method of claim 1, further comprising performing a beam selection inference for a first user equipment based on the server-side neural network model.

4. The method of claim 1, wherein the label dataset corresponds to at least one of:
millimeter wave, mmWave, data associated with at least one of the plurality of clients;
radio measurement data associated with at least one of the plurality of clients; and
network performance data associated with at least one of the plurality of clients.

5. The method of claim 1, wherein the plurality of input datasets correspond to at least one of:
camera data associated with at least one of the plurality of clients;
light detection and ranging, LiDAR, data associated with at least one of the plurality of clients; and
global positioning system, GPS, data associated with at least one of the plurality of clients.

6. The method of claim 1, wherein a first input dataset of the plurality of input datasets is one of:
accessible by a first client of the plurality of clients and not accessible by at least one other client of the plurality of clients; and
only accessible by the first client of the plurality of clients and not accessible by all other clients of the plurality of clients.

7. A server network node configured to communicate with a plurality of clients, each of the plurality of clients being configured with a client-side neural network model, the server network node comprising processing circuitry configured to:
receive a first plurality of client-side neural network model outputs from the plurality of clients, each of the first plurality of client-side neural network model outputs being computed based on at least one of a plurality of input datasets associated with the plurality of clients;
at least one of:
determine at least a portion of a label dataset; and
receive at least a portion of the label dataset from at least one other network node; and
perform a split learning using the first plurality of client-side neural network model outputs and a server-side neural network model with the label dataset.

8. The server network node of claim 7, wherein performing the split learning comprises:
determining, using the server-side neural network model and the first plurality of client-side neural network model outputs, a first plurality of server-side neural network parameters; and
transmitting the first plurality of server-side neural network parameters to each of the plurality of clients.

9. The server network node of claim 7, wherein the processing circuitry is further configured to perform a beam selection inference for a first user equipment based on the server-side neural network model.

10. The server network node of claim 7, wherein the label dataset corresponds to at least one of:
millimeter wave, mmWave, data associated with at least one of the plurality of clients;
radio measurement data associated with at least one of the plurality of clients; and
network performance data associated with at least one of the plurality of clients.

11. The server network node of claim 7, wherein the plurality of input datasets correspond to at least one of:
camera data associated with at least one of the plurality of clients;
light detection and ranging, LiDAR, data associated with at least one of the plurality of clients; and
global positioning system, GPS, data associated with at least one of the plurality of clients.

12. The server network node of claim 7, wherein a first input dataset of the plurality of input datasets is one of:
accessible by a first client of the plurality of clients and not accessible by at least one other client of the plurality of clients; and
only accessible by the first client of the plurality of clients and not accessible by all other clients of the plurality of clients.

13. A method performed by a first client configured to communicate with a server network node, the server network node being configured to communicate with a plurality of clients, the plurality of clients comprising the first client, each of the plurality of clients being configured with a client-side neural network model, the method comprising:
at least one of receiving and determining a first input dataset associated with the first client;
determining, using a first client-side neural network model, a first client-side neural network model output; and
communicating the first client-side neural network model output to the server network node for performing split learning using a plurality of client-side neural network model outputs from the plurality of clients and a server-side neural network model with a label dataset.

14. The method of claim 13, further comprising:
based on the first client being a first user equipment, receiving a beam selection configuration based on a beam selection inference for the first user equipment based on the server-side neural network model.

15. The method of claim 13, further comprising:
based on the first client being a first network node, determining a beam selection configuration based on a beam selection inference for a first user equipment and the first network node based on the server-side neural network model; and
transmitting an indication of the beam selection configuration to the first user equipment.

16. The method of claim 13, wherein the label dataset corresponds to at least one of:
millimeter wave, mmWave, data associated with at least one of the plurality of clients;
radio measurement data associated with at least one of the plurality of clients; and
network performance data associated with at least one of the plurality of clients.

17. The method of claim 13, wherein the first input dataset corresponds to at least one of:
camera data associated with at least one of the plurality of clients;
light detection and ranging, LiDAR, data associated with at least one of the plurality of clients; and
global positioning system, GPS, data associated with at least one of the plurality of clients.

18. The method of claim 13, wherein the first input dataset is one of:
accessible by the first client and not accessible by at least one other client of the plurality of clients; and
only accessible by the first client and not accessible by all other clients of the plurality of clients.

19. A first client configured to communicate with a server network node, the server network node being configured to communicate with a plurality of clients, each of the plurality of clients being configured with a client-side neural network model, the first client comprising processing circuitry configured to:
at least one of receive and determine a first input dataset associated with the first client;
determine, using a first client-side neural network model, a first client-side neural network model output; and
communicate the first client-side neural network model output to the server network node for performing split learning using a plurality of client-side neural network model outputs from the plurality of clients and a server-side neural network model with a label dataset.

20. The first client of claim 19, wherein the processing circuitry is further configured to:
based on the first client being a first user equipment, receive a beam selection configuration based on a beam selection inference for the first user equipment based on the server-side neural network model.

21. The first client of claim 19, wherein the processing circuitry is further configured to:
based on the first client being a first network node, determine a beam selection configuration based on a beam selection inference for a first user equipment and the first network node based on the server-side neural network model; and
transmit an indication of the beam selection configuration to the first user equipment.

22. The first client of claim 19, wherein the label dataset corresponds to at least one of:
millimeter wave, mmWave, data associated with at least one of the plurality of clients;
radio measurement data associated with at least one of the plurality of clients; and
network performance data associated with at least one of the plurality of clients.

23. The first client of claim 19, wherein the first input dataset corresponds to at least one of:
camera data associated with at least one of the plurality of clients;
LiDAR data associated with at least one of the plurality of clients; and
GPS data associated with at least one of the plurality of clients.

24. The first client of claim 19, wherein the first input dataset is one of:
accessible by the first client and not accessible by at least one other client of the plurality of clients; and
only accessible the first client and not accessible by all other clients of the plurality of clients.
